(19) United States
(12) Patent Application Publication
(10) Pub. No.: US 2019/0383903 A1
(43) Pub. Date: Dec. 19, 2019

(54) Gesture recognition system having machine-learning accelerator

(71) Applicant: KaiKuTek INC., Taipei (TW)

(72) Inventors: Yu-Lin Chao, Taipei City (TW); Chieh Wu, Hsinchu City (TW); Chih-Wei Chen, Tainan City (TW); Guan-Sian Wu, Taichung City (TW); Chun-Hsuan Kuo, San Diego, CA (US); Mike Chun Hung Wang, Taipei (TW)

(21) Appl. No.: 16/109,773

(22) Filed: Aug. 23, 2018

Related U.S. Application Data
(60) Provisional application No. 62/684,202, filed on Jun. 13, 2018.

(51) Int. Cl. G01S 7/41; G06N 3/04; G06N 3/08; G01S 7/35; G06F 3/01

(52) U.S. Cl. CPC G01S 7/417; G06N 3/04; G06F 3/017; G01S 7/352; G06N 3/08

(57) ABSTRACT

A gesture recognition system includes a Frequency modulated continuous waveform radar system. First and second channels of the signal reflected by the object are preprocessed and respectively sent to first and second feature map generators. A machine-learning accelerator is configured to receive output from the first and second feature map generators and form frames fed to a deep neural network realized with a hardware processor array for gesture recognition. A memory stores a compressed set of weights as fixed-point, low rank matrices that are directly treated as weights of the deep neural network during inference.

### CROSS REFERENCE TO RELATED APPLICATIONS

This application claims priority of U.S. Provisional Patent Application No. 62/684,202, filed Jun. 13, 2018, and incorporated herein by reference in its entirety.

### BACKGROUND OF THE INVENTION

### 1. Field of the Invention

This application generally relates to a gesture recognition system and more particularly to a gesture recognition system having a machine-learning accelerator.

### 2. Description of the Prior Art

The category of gesture recognition devices include input interfaces that visually detect a gesture articulated by a user's hand. In general, most gesture recognition systems today lack reliability, flexibility, and speed.

### SUMMARY OF THE INVENTION

A gesture recognition system having machine-learning accelerator comprises a Frequency modulated continuous waveform radar system having a transmitter transmitting a predetermined frequency spectrum signal to an object, a first receiver receiving a first channel of the signal reflected by the object, a first signal preprocessing engine serially coupled between the first receiver and a first feature map generator, a second receiver for receiving a second channel of the signal reflected by the object, a second signal preprocessing engine serially coupled between the second receiver and a second feature map generator, a clear channel assessment block coupled to receive output from the first and second feature map generators, and a machine-learning accelerator configured to receive output from the first and second feature map generators and form frames fed to a deep neural network realized with a hardware processor array for gesture recognition. The machine-learning accelerator comprises a machine learning hardware accelerator scheduler configured to act as an interface between the hardware processor array and a microcontroller unit, and a memory storing a set of compressed weights fed to the deep neural network.

A method of gesture recognition comprises transmitting a predetermined frequency spectrum signal to an object, receiving a first channel of the signal reflected by the object, sending the first channel of the signal to a first feature map generator via a first signal preprocessing engine, receiving a second channel of the signal reflected by the object, sending the second channel of the signal to a second feature map generator via a second signal preprocessing engine, skipping portions of the spectrum occupied by other devices, a machine-learning accelerator receiving output from the first and second feature map generators and forming frames fed to a deep neural network realized with a hardware processor array for gesture recognition, and utilizing recognized gestures to control and application program.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a gesture recognition system according to an embodiment.

FIG. 2-FIG. 3 describe 10 mini-gestures according to embodiments of the invention.

FIG. 4 describes micro-gestures according to embodiments of the invention.

### DETAILED DESCRIPTION

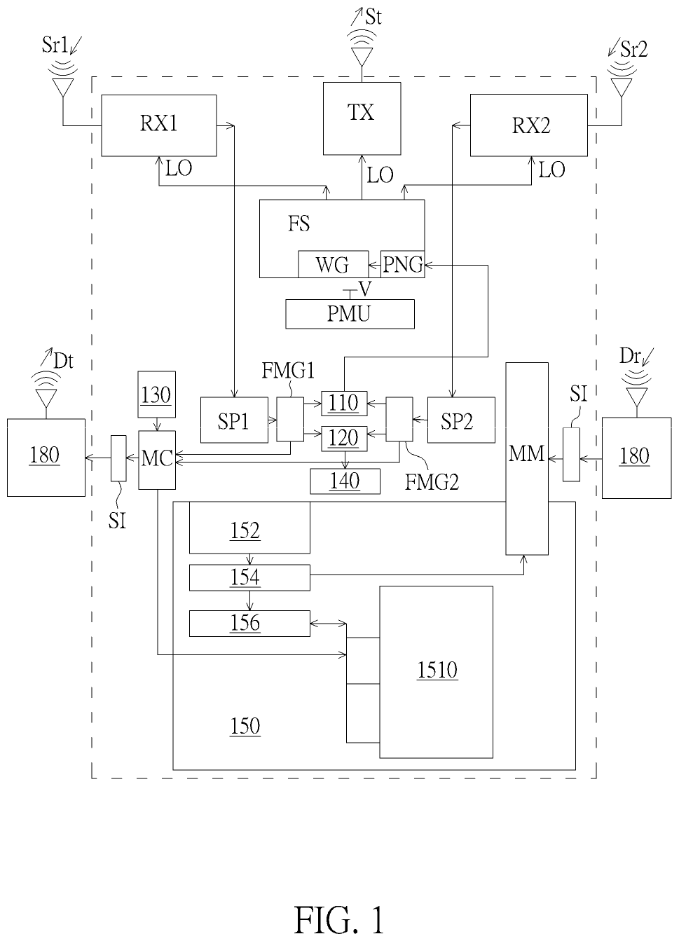

FIG. 1 illustrates an example anti-jamming/collision avoidance system 100 according to an embodiment. The system 100 may include an FMCW (Frequency modulated continuous waveform) radar system for hand/finger gesture recognition application using a hardware DNN (Deep Neural Network) accelerator and a customizable gesture-training platform. The system 100 may process signals of high frequency such as 60 GHz. The system 100 may have fine movement sensing capability. The system 100 may be implemented as an SoC (System on Chip), a chipset, or an integrated device having at least a chip and other elements, which may be connected via a circuit board.

As shown in FIG. 1, the radar has two channels of receivers RX1-RX2 and one channel of transmitter TX. The receiver RX1 may operate for a first receiving channel and the receiver RX2 may operate for a second receiving channel.

The entire algorithm for recognition is based on Machine Learning and Deep Neural Network (ML and DNN). The ML/DNN may receive outputs from Feature Map Generators FMG1-FMG2 and form frames for gesture recognition. Because of the computational workload and real time, low latency requirement, the recognition algorithm is realized with a special hardware array processor. A dedicated scheduler (e.g. a machine learning hardware accelerator scheduler 154) may act as an interface between this array processor and the MCU (microcontroller unit). Furthermore, a special compression algorithm may be applied to reduce memory requirements for weights. The compression algorithm compresses the weights into low rank matrices and converts them to a fixed-point form. The fixed-point, low rank matrices can be directly treated as a weight during inference. Therefore, weight decompression on the device side is not required.

The above described system 100 is only an example and not to be considered as limiting. Any FHSS FMCW radar system for hand/finger gesture recognition application using a hardware DNN accelerator using store weights and a customizable gesture-training platform is suitable for gesture recognition as described herein.

In the proposed system, a machine-learning accelerator may be used for gesture detection recognition dedicatedly and may be disposed in the proposed system locally according to an embodiment. The proposed system may be a stand-alone system, which is able to operate for gesture recognition independently. Hence, it is more convenient to integrate the proposed system into another device (e.g. a mobile phone, a tablet, a computer, etc.), and engineering effect may also be improved. For example, the time and/or power consumption required for gesture recognition may be reduced. The machine learning accelerator (e.g. 150) may be used to reduce the required gesture processing time at the system 100, and the weights used by the machine learning accelerator (e.g. 150) may be obtained from gesture training. Gesture training may be performed by a remote ML server such as a cloud ML server.

As a typical application scenario, a fixed number of gestures may be collected and used for training. Gesture recognition using a plurality of weights may be improved upon by performing training using a set of collected gestures. For example, 1000 persons to generate 1000 samples may perform a single gesture, and a cloud ML server may then process these 1000 samples. The cloud ML server may perform gesture training using these samples to obtain a corresponding result. The result may be a set of weights used in the gesture inference process. So when a user performs a gesture, this set of weights may be employed in the calculation process to enhance recognition performance.

A basic set of gestures may therefore be realized using this trained set of weights. In addition, the proposed system may allow a user to have customized gestures. A user's personal gesture may be recorded and then sent to Cloud ML server via an external Host processor (e.g. 180) for subsequent gesture training. The external Host processor (e.g. 180) may run a Custom Gesture Collection Application program and may be connected to a Cloud server via Internet through wire or wirelessly. The results of training (e.g. a set of weights) may then be downloaded so the user's own gesture may be used as well.

As mentioned above, signals used for gesture sensing may have frequency in the 60 GHz range. Due to its corresponding millimeter wavelength, the proposed system can detect minute hand/finger movement with millimeter accuracy. Special processing of phase information for radar signal may be required. A special Phase Processing Engine (e.g. a phase extractor/unwrapper 120) in FIG. 1 may be developed and used for such purpose. A Power management unit (PMU) can connect to a voltage V and supply power to the system.

In FIG. 1, reference signs are interpreted as follows.

| Reference signs | Descriptions |
|---|---|
| 100 | Anti-jamming/collision avoidance system |
| 110 | Clear channel assessment engine |
| 120 | Phase extractor/unwrapper |
| 130 | Customized gesture collection engine |
| 140 | Fine movement sensing engine |
| 150 | DNN hardware accelerator engine |
| 152 | MCU running App (app program) |
| 154 | ML (machine learning) hardware accelerator |
| | scheduler |
| 156 | Memory for PE(processing element) intermediate |
| | results |
| 180 | External system host CPU with Wi-Fi or Bluetooth |
| | module connected |
| 1510 | Array processor |
| Dr | Data from cloud server with gesture training |
| | results or updated weights |
| Dt | Data sent to cloud server for customized gesture |
| | training |
| FMG1 | Feature map generate (of channel 1) |
| FMG2 | Feature map generate (of channel 2) |
| FS | Frequency synthesizer |
| LO | Local oscillation signal for synchronization |
| MC | Memory for customized gesture collection |
| MM | Main memory for DNN Weights |
| PMU | Power management unit |
| PNG | PN code generator/Channel selector |
| RX1 | Receiver (of channel 1) |
| RX2 | Receiver (of channel 2) |
| SI | Serial interface |
| SP1, SP2 | Signal processing engine |
| Sr1, Sr2 | Signal received for gesture detection |
| St | Signal transmitted for gesture detection |
| V | Main Supply |
| WG | Waveform generator with FHSS |

An Anti-Jamming/Collision Avoidance 60 GHz FHSS FMCW Radar System for Hand/Finger Gesture Recognition Application with Hardware DNN accelerator, Customizable Gesture training platform and fine movement sensing capability. The Radar has two channels of Receivers (RX) and one channel of Transmitter (TX).

Anti-jamming/Collision Avoidance may be achieved by turning on the two RX's and swept the entire 57-67 GHz spectrum first. After processing signal through the entire RX chain, the Clear Channel Assessment Block may tell which part of spectrum may be currently occupied by other users/devices. This knowledge may be used by the FHSS PN Code generator, so the system may skip these portions of spectrum to avoid collision. On top of avoidance, FHSS may be also used to reduce further such occurrence on a statistical basis. This Anti-jamming/Collision Avoidance algorithm may be done on a Frame-to-Frame basis.

The entire algorithm for recognition may be based on Machine Learning and Deep Neural Network (ML and DNN). The ML/DNN takes outputs from the Feature Map Generator and forms Frames for gesture recognition. Because of the computational workload and real time, low latency requirement, the algorithm may be realized with special hardware processor array. A dedicated Scheduler acts as an interface between the array and MCU. Furthermore, since special compression algorithm may be applied to reduce memory requirement for weights, the fixed-point, low rank matrices can be directly treated as weights during inference.

As a basic usage scenario, a fixed number of gestures may be collected, trained and results (Weights) applied to all devices, so a basic set of gestures for recognition may be realized. In addition, the system allows users to have customized gestures—his/her own gesture may be recorded and sent to an external host processor running a Custom Gesture Collection Application program and via the Internet, to our Cloud server for training. The results may then be downloaded so his/her own gesture may be used as well.

In general, a Deep Neural Network takes an input frame or frames and using the weights, may generate a vector trace that falls into one of a plurality of vector spaces determined by the training of the Deep Neural Network. How strongly the vector trace falls within each of the vector spaces is converted into probabilities of with which in a stored set of gestures, a given input gesture corresponds. Unfortunately, even the best Deep Neural Networks can sometimes determine the input gesture incorrectly. This often is because respective vector spaces in the Deep Neural Networks generated by the “correct” gesture and the “incorrect” gesture are too close together. When the vector spaces are too close together, tiny variations in the input tip the most probable gesture from being “correct” to being “incorrect”.

With this in mind, the inventors have realized that the best way substantially to avoid this problem of incorrect classification is to separate the vector spaces as much as possible. This can be done during Deep Neural Network training by determining specific gestures whose ensuing vector traces are as far apart as possible, design considerations permitting. The following is a list of specific mini-gestures and a list of specific micro gestures determined to separate the vector spaces in a Deep Neural Network as much as possible. The specific names given each mini-gesture or micro-gesture are arbitrary and may be changed without altering the definition of the gestures.

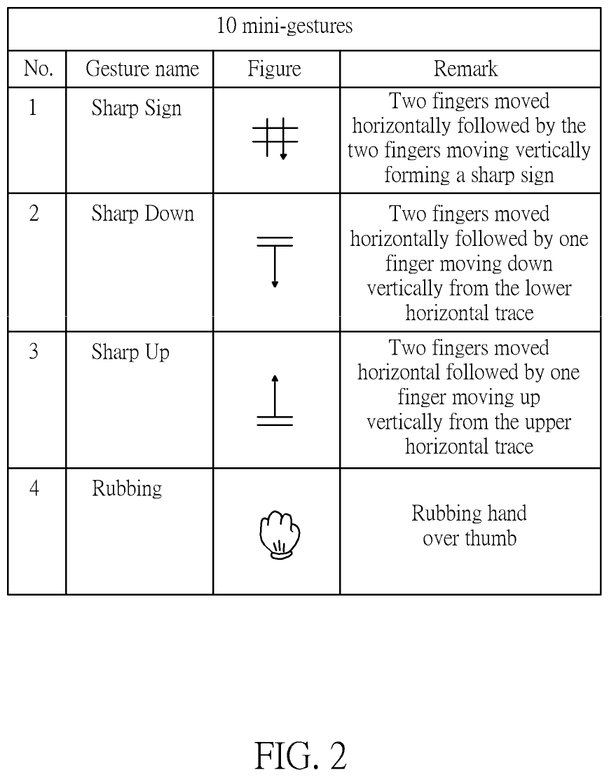

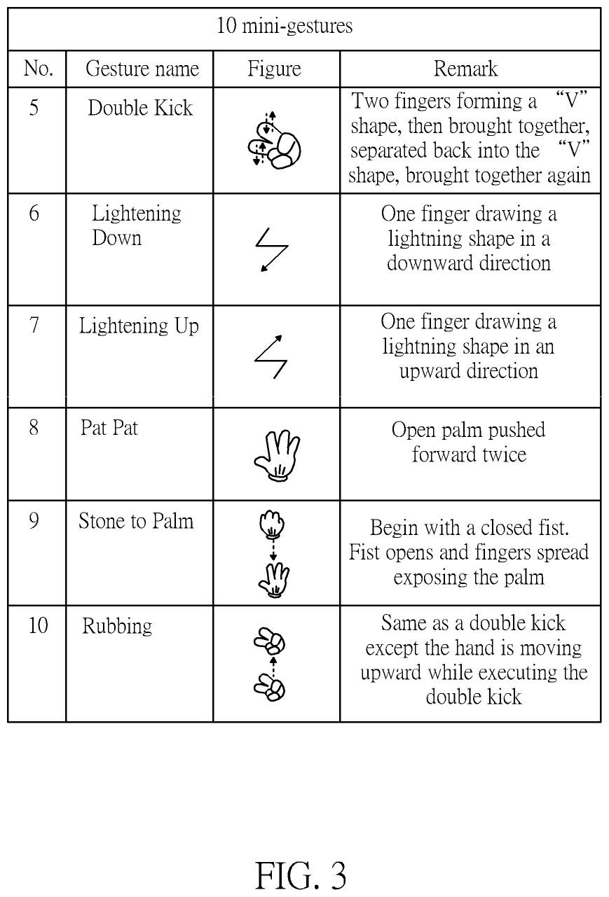

FIG. 2 and FIG. 3 illustrate the following 10 specific mini-gestures that separate the vector spaces in a Deep Neural Network as desired. When describing the mini-gestures or micro-gestures, the term “traces” refers to an imaginary line drawn in the air by finger(s) or hand.

No. 1: A Sharp Sign—Traces formed by two extended fingers moved horizontally followed by the two fingers moving vertically to forming a sharp sign.

No. 2: A Signal Down—Traces formed by two extended fingers moved horizontally followed by one finger moving down vertically from the lower horizontal trace.

No. 3: A Signal Up—Traces formed by two extended fingers moved horizontally followed by one finger moving up vertically from the lower horizontal trace.

No. 4: Rubbing—Traces formed by rubbing hand over thumb.

No. 5: Double Kick—Traces formed by two fingers are extended to form a “V” shape, then brought together while still extended, separated back into the “V” shape, then brought together again. Alternatively, traces formed by two fingers that are extended together, the extended fingers separated to form a “V” shape, then brought together while still extended, and separated back into the “V” shape.

No. 6: Lightening Down—Traces formed by one extended finger drawing a lightning shape (zigzagged line) in a downward direction.

No. 7: Lightening Up—Traces formed by one extended finger drawing a lightning shape (zigzagged line) in an upward direction.

No. 8: Pat Pat—Traces formed by an open palm being pushed forward twice in succession.

No. 9: Stone to Palm—Traces formed by beginning with a closed fist. Fist opens and fingers extend and spread exposing the palm.

No. 10: Kick Climb—Traces formed by a mini-gesture similar to a double kick except the hand is moving upward while executing the double kick.

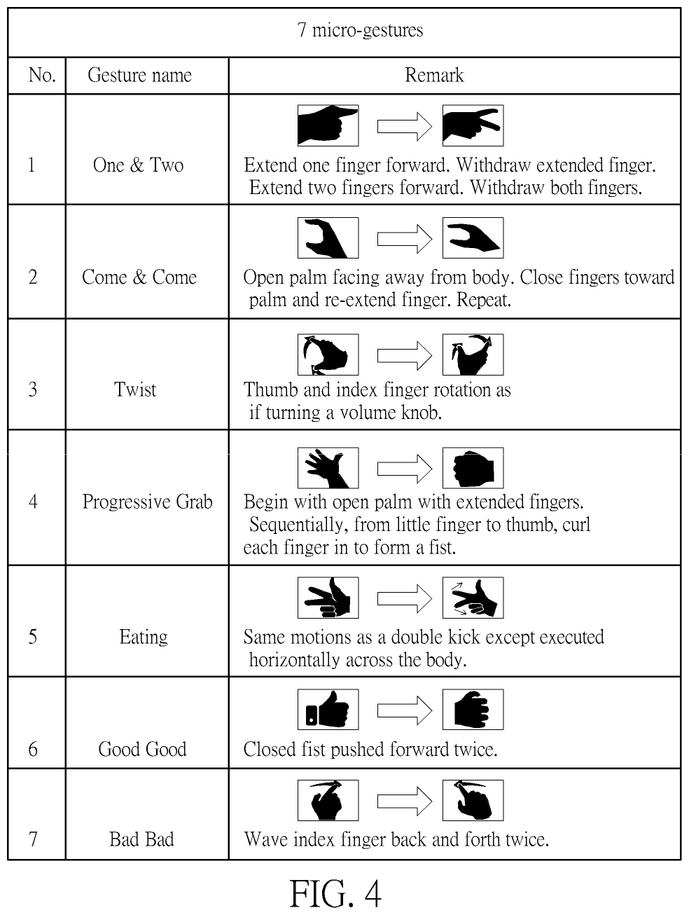

FIG. 4 illustrates the following seven specific micro-gestures that separate the vector spaces in a Deep Neural Network as desired.

No. 1: One & Two-Traces formed by extending one finger forward, withdrawing the extended finger, then extend two fingers forward before withdrawing both fingers.

No. 2: Come & Come—Traces formed by an open palm facing away from body. Fingers are curled in toward the palm, and then re-extended. Repeat.

No. 3: Twist—Traces formed by rotation of a thumb and index finger as if turning a volume knob.

No. 4: Progressive Grab—Traces formed beginning with an open palm with extended fingers and sequentially, from little finger to thumb, curling each finger in to form a fist.

No. 5: Eating—Traces formed by the same motions as a double kick except executed horizontally across the body.

No. 6: Good Good—Traces formed by a closed fist with thumb extended pushed forward twice.

No. 7: Bad Bad—Traces formed by waving an index finger back and forth twice.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A gesture recognition system having machine-learning accelerator comprising:
a Frequency modulated continuous waveform radar system comprising:
a transmitter for transmitting signal to an object; and
at least one receiver for receiving the signal reflected by the object;
a machine-learning accelerator configured to receive processed output from the at least one receiver and form frames fed for inference to a deep neural network realized with a hardware processor array for gesture recognition; and
a memory comprising a set of compressed weights utilized by the deep neural network during the inference, the set of compressed weights generated by training another deep neural network on a remote server to recognize mini-gestures or micro-gestures of at least one of FIG. 2, FIG. 3, and FIG. 4.

2. The gesture recognition system of claim 1 further comprising a machine learning hardware accelerator scheduler configured to act as an interface between the hardware processor array and a microcontroller unit.

3. The gesture recognition system of claim 1 wherein the set of compressed weights is stored in a compressed form as fixed-point, low rank matrices that are directly treated as weights during inference.

4. The gesture recognition system of claim 1 wherein the set of compressed weights is changeable so that the deep neural network will recognize customized gestures.

5. A gesture recognition system having machine-learning accelerator comprising:
a Frequency modulated continuous waveform radar system comprising:
a transmitter for transmitting a predetermined frequency spectrum signal to an object;
a first receiver for receiving a first channel of the signal reflected by the object;
a first signal-preprocessing engine serially coupled between the first receiver and a first feature map generator;
a second receiver for receiving a second channel of the signal reflected by the object;
a second signal-preprocessing engine serially coupled between the second receiver and a second feature map generator;
a clear channel assessment block coupled to receive output from the first and second feature map generators; and
a machine-learning accelerator configured to receive output from the first and second feature map generators and form frames fed to a deep neural network realized with a hardware processor array for gesture recognition, the machine-learning accelerator comprising:
a machine learning hardware accelerator scheduler configured to act as an interface between the hardware processor array and a microcontroller unit; and
a memory comprising compressed a set of compressed weights utilized by the deep neural network during the inference, the set of weights generated on a remote server to recognize predetermined mini-gestures or micro-gestures.

6. The gesture recognition system of claim 5, wherein the predetermined mini-gestures comprise a Sharp Sign—traces formed by two extended fingers moved horizontally followed by the two fingers moving vertically to forming a sharp sign, a Signal Down—traces formed by two extended fingers moved horizontally followed by one finger moving down vertically from the lower horizontal trace, a Signal Up—traces formed by two extended fingers moved horizontally followed by one finger moving up vertically from the lower horizontal trace, Rubbing—traces formed by rubbing hand over thumb, and Double Kick—traces formed by two fingers are extended to form a “V” shape, then brought together while still extended, separated back into the “V” shape, then brought together again or formed by two fingers that are extended together, the extended fingers separated to form a “V” shape, then brought together while still extended, and separated back into the “V” shape.

7. The gesture recognition system of claim 5, wherein the predetermined mini-gestures comprise a Lightening Down—traces formed by one extended finger drawing a lightning shape in a downward direction, Lightening Up—traces formed by one extended finger drawing a lightning shape in an upward direction, Pat Pat—traces formed by an open palm being pushed forward twice in succession, Stone to Palm—traces formed by beginning with a closed fist, then fist opens and fingers extend and spread exposing the palm, and Kick Climb—traces formed by two fingers are extended to form a “V” shape, then brought together while still extended, separated back into the “V” shape, then brought together again or formed by two fingers that are extended together, the extended fingers separated to form a “V” shape, then brought together while still extended, and separated back into the “V” shape.

8. The gesture recognition system of claim 5, wherein the predetermined micro-gestures comprise One & Two—traces formed by extending one finger forward, withdrawing the extended finger, then extending two fingers forward before withdrawing both fingers, Come & Come—traces formed by an open palm facing away from body and fingers repeatedly curled in toward the palm, Twist—traces formed by rotation of a thumb and index finger as if turning a volume knob, Progressive Grab—traces formed beginning with an open palm with extended fingers and sequentially, from little finger to thumb, curling each finger in to form a fist, Eating—traces formed by two fingers are extended to form a “V” shape, then brought together while still extended, separated back into the “V” shape, then brought together again or formed by two fingers that are extended together, the extended fingers separated to form a “V” shape, then brought together while still extended, and separated back into the “V” shape executed horizontally across the body, Good Good—traces formed by a closed fist with thumb extended pushed forward twice, and Bad Bad—traces formed by waving an index finger back and forth twice.

9. The gesture recognition system of claim 5 wherein the predetermined frequency spectrum signal is in the 60 GHz range, plus or minus 10%.

10. The gesture recognition system of claim 5 further comprising a microcontroller unit configured to run an application program that takes recognized gestures as input.

11. A method of gesture recognition comprising:
transmitting a predetermined frequency spectrum signal to an object;
receiving a reflected signal reflected by the object;
a machine-learning accelerator receiving a processed reflected signal and forming frames fed for inference to a deep neural network realized with a hardware processor array for gesture recognition;
storing, in a memory, a set of compressed weights utilized by the deep neural network during the inference, the set of compressed weights generated by a remote server to recognize mini-gestures or micro-gestures of at least one of FIG. 2, FIG. 3, and FIG. 4; and
utilizing recognized gestures to control an application program.

12. The method of claim 11 further comprising utilizing a machine learning hardware accelerator scheduler configured to act as an interface between the hardware processor array and a microcontroller unit.

13. The method of claim 11 further comprising compressing the set of weights stored in the memory as fixed-point, low rank matrices that are directly treated as weights during inference.

14. The method of claim 11 further comprising changing the set of weights to a changed set of weights so that the deep neural network will recognize customized gestures.

15. The method of claim 14 further comprising obtaining the changed set of weights by training a deep neural network on the remote server with the customized gestures as input.

16. The method of claim 11, wherein the predetermined mini-gestures comprise a Sharp Sign—forming traces by two extended fingers moving horizontally followed by the two fingers moving vertically to forming a sharp sign, a Signal Down—forming traces by two extended fingers moving horizontally followed by one finger moving down vertically from the lower horizontal trace, a Signal Up—forming traces by two extended fingers moving horizontally followed by one finger moving up vertically from the lower horizontal trace, Rubbing—forming traces by rubbing hand over thumb, and Double Kick—forming traces by two fingers extending to form a “V” shape, then brought together while still extended, separated back into the “V” shape, then brought together again or formed by two fingers extending together, the extended fingers separated to form a “V” shape, then brought together while still extended, and separated back into the “V” shape.

17. The method of claim 11, wherein the predetermined mini-gestures comprise a Lightening Down—forming traces by one extended finger drawing a lightning shape in a downward direction, Lightening Up—forming traces by one extended finger drawing a lightning shape in an upward direction, Pat Pat—forming traces by an open palm being pushed forward twice in succession, Stone to Palm—forming traces by beginning with a closed fist, then fist opens and fingers extend and spread exposing the palm, and Kick Climb—forming traces by two fingers are extended to forma “V” shape, then brought together while still extended, separated back into the “V” shape, then brought together again or formed by two fingers that are extended together, the extended fingers separated to form a “V” shape, then brought together while still extended, and separated back into the “V” shape.

18. The method of claim 11, wherein the predetermined micro-gestures comprise One & Two—forming traces by extending one finger forward, withdrawing the extended finger, then extending two fingers forward before withdrawing both fingers, Come & Come—forming traces by an open palm facing away from body and fingers repeatedly curled in toward the palm, Twist—forming traces by rotation of a thumb and index finger as if turning a volume knob, Progressive Grab—forming traces beginning with an open palm with extended fingers and sequentially, from little finger to thumb, curling each finger in to form a fist, Eating—forming traces by two fingers extended to form a “V” shape, then brought together while still extended, separated back into the “V” shape, then brought together again or formed by two fingers that are extended together, the extended fingers separated to form a “V” shape, then brought together while still extended, and separated back into the “V” shape executed horizontally across the body, Good Good—forming traces by a closed fist with thumb extended pushed forward twice, and Bad Bad—forming traces by waving an index finger back and forth twice.
